(19) United States
(12) Patent Application Publication
(10) Pub. No.: US 2020/0044394 A1
(43) Pub. Date: Feb. 6, 2020

(54) Slotted Contact For A Female Connector Of The Jack Type For A 4.3-10 Coaxial Connection System

(71) Applicant: RADIALL SA, Aubervillers (FR)

(72) Inventors: Shan QIN, Shanghai (CN); Claude BROCHETON, Coublevie (FR)

(21) Appl. No.: 15/531,947

(22) PCT Filed: Apr. 7, 2017
(86) PCT No.: PCT/CN2017/079782

§ 371 Date: May 31, 2017

(51) Int. Cl. H01R 13/642; H01R 24/40; H01R 13/11

(52) U.S. Cl. CPC H01R 13/642; H01R 2103/00; H01R 13/111; H01R 24/40

(57) ABSTRACT

The present application relates to a slotted contact (31), intended to be arranged on the periphery of a central contact to form a ground contact of a 4.3-10 female connector, including strips which are horn shaped as petals (310), each petal being designed with a projection (313) extending inwards such that in case of a mismating of a ground contact of a 4.1-9.5 plug connector into the projection, the front face of the projection (313) comes into abutment with the ground contact of a 4.1-9.5 plug connector.

### TECHNICAL FIELD

The present invention relates to a slotted contact for a female connector, of the jack type, for a 4.3-10 coaxial connection system, intended in particular to transmit radio frequency RF signals.

The applications particularly targeted by the invention are the connection of telecommunication equipment such as base transceiver stations BTS, RRU/RRH (remote radio unit/remote radio head) units and distributed antenna system for the wireless communications market.

The invention more particularly aims to propose a solution in order to avoid a destructive connection between a male connector of a connection system, designed under the series 4.1-9.5 standard designation, hereinafter a 4.1-9.5 male connector, and a female connector of a connection system, designed under the series 4.3-10 standard designation, hereinafter a 4.3-10 female connector.

### PRIOR ART

The market and the prior art already feature power connectors of coaxial type for low passive intermodulation and dedicated to the telecommunications sector for cellular radio telephony infrastructures.

The trend in this market is to minimize the generation of passive intermodulation products. This is because, although the passive components, such as coaxial connectors and RF loads, were considered to be linear, it has been found that in reality these components were susceptible to behave as intermodulation generators, that is to say non-linear generators of unwanted modulation of the RF signals, which can lead to a distortion of the signals output from said components.

Thus, the connectors manufacturers, and in particular the applicant, have already developed, from proven coaxial connectors, connectors with high RF performance levels, notably with low intermodulation levels, such as those marketed under the series 4.1-9.5 and 4.3-10 designations which are IEC standards.

More particularly, the RF coaxial connection system of the 4.1-9.5 type is a standard under the reference IEC 60169-11 Ed. 1.0 (1977), which defines an inner diameter of the outer conductor (peripheral contact) of a 9.5 mm (0.374 inch) value with a characteristic impedance of 50 ohms and with a screw coupling as a locking device for mechanically locking the plug to the jack when they are in mutual connection configuration.

The RF coaxial connection system of the 4.3-10 type is a standard project under the reference IEC 61169-54:2016, which defines an inner diameter of the outer conductor (peripheral contact) of a 10 mm (0.394 inch) value with a nominal characteristic impedance of 50 ohms.

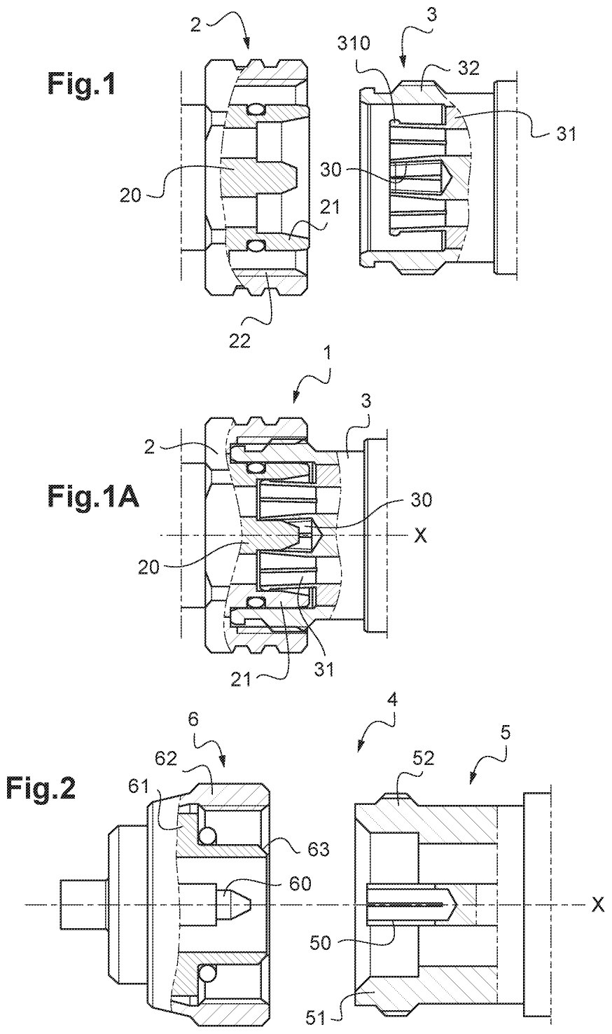

FIGS. 1 and 1A show, in longitudinal cross section, a coaxial power connection system 1, which has been marketed since several years under the series 4.3-10 designation, as specified in the standard IEC 61169-54:2016.

The jack 3 comprises a central contact 30 and a peripheral contact 31 arranged at the periphery of the central contact, forming a ground contact.

The plug 2 itself comprises a central contact 20 and a peripheral contact 21 arranged at the periphery of the central contact, forming a ground contact. For better contact between the peripheral contact 21 of the plug 2 and the slotted peripheral contact 31 of the jack 3, the free end of the slotted peripheral contact 31 is horn shaped as a petal 310 and can withstand the elastic deformation.

In order to mechanically lock the mutual connection between plug and jack, a locking nut 22 is provided, to be screwed on the threads 32, around both the plug and the jack.

In this connection system 1, the electrical and mechanical functions can be separated, and electrical performances shall not be depended on the coupling torque, such that the connection has low intermodulation even mated with a small torque applied, typically on the order of 1 N·m. This allows the operator to mate the connection system conveniently.

FIG. 2 shows, in longitudinal cross section, a coaxial power connection system 4, which has been marketed since more than 30 years under the series 4.1-9.5 designation, as specified in the standard IEC 60169-11.

The jack 5 comprises a central contact 50 and a peripheral contact 51 arranged at the periphery of the central contact, forming a ground contact.

The plug 6 itself comprises a central contact 60 and a peripheral contact 61 arranged at the periphery of the central contact, forming a ground contact.

In order to mechanically lock the mutual connection between plug and jack, a locking nut 62 is provided, to be screwed on the threads 52, around both the plug and the jack.

In this connection system 4, a low intermodulation can be achieved only if a high fastening torque is applied, typically on the order of 10 N·m.

A 4.1-9.5 connection system 4 and a 4.3-10 connection system 1 are dedicated to the same applications, notably in the field of telecommunications as mentioned above and may be found simultaneously on the same equipment.

The threads 22, 32 and 52, 62 to achieve the locking in both 4.1-9.5 and 4.3-10 connection systems 1; 4 are identical, of the M20×1 type.

Moreover, the external size of the connectors 2,3 is the same than for connectors 5,6, and the outer shape of the plug 2 of the 4.3-10 system 1 is similar than the plug 6 of the 4.1-9.5 system 4.

Due to these identical sizes and similar shapes, an operator in charge of making the connection can easily confuse these two connections systems 1 and 4, when manipulating them.

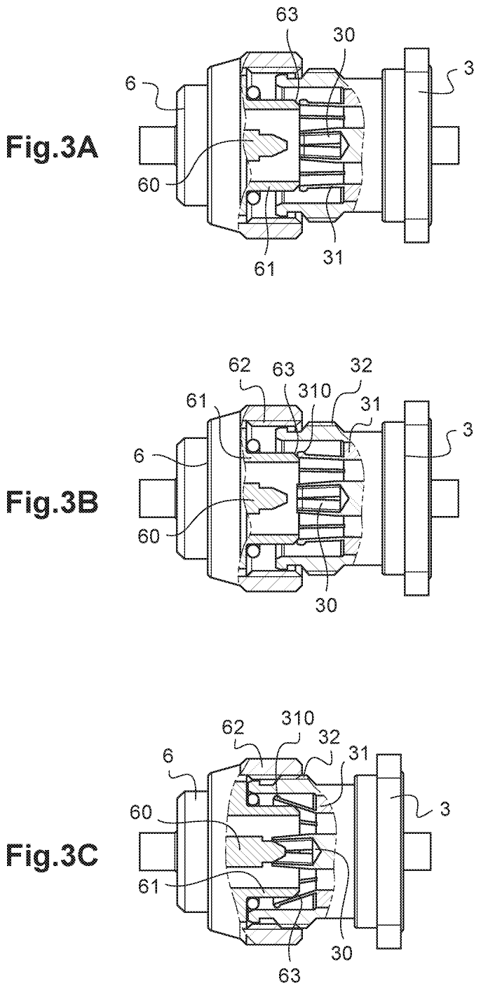

If such an error on the types of connection system arrives, damages occur on the connectors, as shown on FIGS. 3A, 3B and 3C.

When an operator accidentally makes a mismating between a 4.1-9.5 plug 6 and a 4.3-10 jack 3, the peripheral contact 61 with has a chamfer 63 at the front end of the interface of the plug 6 can easily go into the slotted peripheral contact 31, after tighten the coupling nut 62 with thread 32 even manually. Then, it can occur a plastic deformation of the petals 310 of the peripheral contact 31, as shown in FIG. 3C.

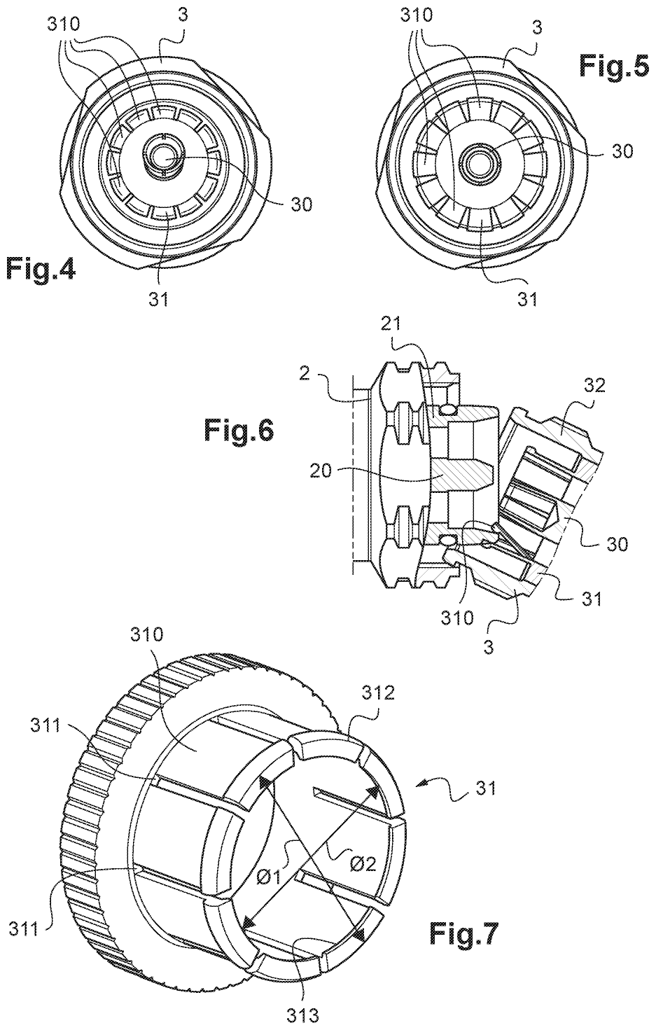

FIG. 4 shows a normal state of the peripheral contact 31 of the jack 3 while FIG. 5 shows a damaged jack 3 in which the peripheral contact 31 has been undesired plastically deformed with its petals 310 completely apart from their normal resting position.

Additionally, it is possible that during a connexion between a 4.3-10 plug and a 4.3-10 jack, the 4.3-10 plug 2 has a big tilting angle of 15˜25°, due to the short guidance during the connexion operation, such that the petals 310 of the slotted peripheral contact 31 of the 4.3-10 jack 3 may have a big deformation as shown on FIG. 6.

Because no mechanical protection is provided, as described above it is possible to permanently deform in a plastic state, the slotted peripheral contact 31, if the material is not enough elastic in order to resist to additional lateral forces, for example, which can be brought from the gravity of the mass of the cable assembly which is linked to the jack 3.

In the same way, such an important deformation may occur during an unmating operation as well. Such deformations would drastically reduce the intermodulation performance of the connexion.

There is therefore a need to further improve the RF coaxial connection systems of the 4.3-10 type, notably in order to prevent any mismating between a 4.1-9.5 male connector and a 4.3-10 female connector.

Additionally, there is a need to increase the robustness of a 4.3-10 connexion, and to achieve a mechanical protection for the slotted peripheral contact of a 4.3-10 female connector during the mating and unmating operations. The invention aims also to address all or some of this (these) need(s).

### Explanation of the Invention

The subject of the invention is thus a slotted contact, intended to be arranged on the periphery of a central contact to form a ground contact of a 4.3-10 female connector, comprising strips which are horn shaped as petals, each petal being designed with a projection extending inwards such that in case of a mismating of a ground contact of a 4.1-9.5 plug connector into said projection, the front face of the projection comes into abutment with said ground contact of a 4.1-9.5 plug connector.

According to an advantageous embodiment, the inwards projection are located at the free end of the petals.

Thus, the invention mainly consists to modify slightly the slotted contact with inwards projections which will serve as abutment during a mismating of a ground contact of a 4.1-9.5 plug connector.

In other words, these inwards projections, which are preferably designed only at the free end of the elastic slotted peripheral contact, avoids the undesired deformation (damage) of this latter.

A female connector with a slotted contact as a ground contact according to the invention meets the requirement of a jack under the series 4.3-10 designation.

A 4.3-10 female connector with a slotted contact having inwards projections according to the invention has the following advantages:
it prevents any accidental mating between a 4.3-10 female connector and a 4.1-9.5 plug connector, and therefore it avoids damages which would occur in case of mismating of a 4.1-9.5 male connector;
it mechanically protects the slotted peripheral contact during mating and unmating operations of series 4.3-10 connector systems, thanks to the rigidity induced by the inwards projections, avoiding degradation of the intermodulation levels due to any undesired deformation of the petals of the peripheral contact;
the inwards projections according to the invention are very simple to manufacture according to the usual process of a slotted contact
the inwards projections have a very slight influence on the RF electrical performances, especially no influence on the intermodulation performances, when used in a 4.3-10 jack, a 4.3-10 female connector (jack) mated with a 4.3-10 plug connector. In particular, in the embodiment where the inwards projections are located at the free end of the slotted contact, said projections may be so thin thickness that they do not disturb the voltage standing wave ratio (VSWR);
no additional piece is required to serve as an abutment with regard to a ground contact of a 4.1-9.5 male connector.

The inwards projections are made preferably integral with the slotted contact. The material of the unique piece may be in brass, in cupro-beryllium (CuBe2) or in any other elastic and high mechanical resistance material.

Advantageously, the inwards projections defining an inner diameter (Ø₂) which is inferior or approximately equal to the inner diameter of the ground contact of a 4.1-9.5 plug connector. The inner diameter (Ø₂) may be thus approximately equal to 9.5 mm.

Preferably, the height (h) of the projections compared to the inner diameter of the slotted contact is equal at least to 0.2 mm, preferably inferior or equal to 0.5 mm.

In an advantageous variant, the projections have a longitudinal cross-section which is decreasing from the exterior towards the interior of the slotted contact. The projections may have a longitudinal cross-section which is a rectangular trapezoid.

It is possible to have thin projections but sufficient thick to achieve the abutment function: in this aim, the projections may have a thickness which is at least equal to 0.2 mm, but inferior or equal to 2.5 mm.

The invention concerns also a female connector of the 4.3-10 jack type for a coaxial connection system, intended to transmit radio frequency RF signals, of longitudinal axis X, the female connector comprising:
a central contact,
a peripheral slotted contact such as described above, arranged on the periphery of the central contact, forming a ground contact.

The invention concerns at last a coaxial connection system marketed under the series 4.3-10 standard designation, comprising a male connector of the type plug and a female connector of the jack type according to claim 10.

### DETAILED DESCRIPTION

Other advantages and features of the invention will become more apparent on reading the detailed description of exemplary implementations of the invention, given as illustrative and non-limiting examples with reference to the following figures in which:

FIGS. 1 and 1A are longitudinal cross-sectional views of a coaxial connection system under series 4.3-10 according to the prior art, the plug and the jack being respectively spaced one from the other in a ready position to be connected, and in mutual connection and locked configuration;

FIG. 2 is a longitudinal cross-sectional view of a coaxial connection system according to the prior art, marketed under the series 4.1-9.5, the plug and the jack being spaced one from the other, in a ready position to be connected;

FIGS. 3A, 3B and 3C are a longitudinal cross section of a 4.1-9.5 plug and a 4.3-10 jack according to the prior art, during a mismating operation, respectively when the peripheral contact of the 4.1-9.5 plug begins to be in a physical contact with the peripheral contact of the 4.3-10 jack and when the undesired insertion is made;

FIG. 4 is a reproduction of a photography of a 4.3-10 jack according to the prior art, after a correct mating and unmating with a complementary 4.3-10 plug;

FIG. 5 is a reproduction of a photography of a 4.3-10 jack according to the prior art, after a mismating with a 4.1-9.5 plug according to the prior art, FIG. 5 showing the undesired permanent deformation of a peripheral contact of the 4.3-10 jack;

FIG. 6 is a longitudinal cross-sectional view of a 4.3-10 plug and a 4.3-10 jack according to the prior art, during a connexion operation in which a tilting angle is involved;

FIG. 7 is a perspective view of an example of a slotted contact according to the invention;

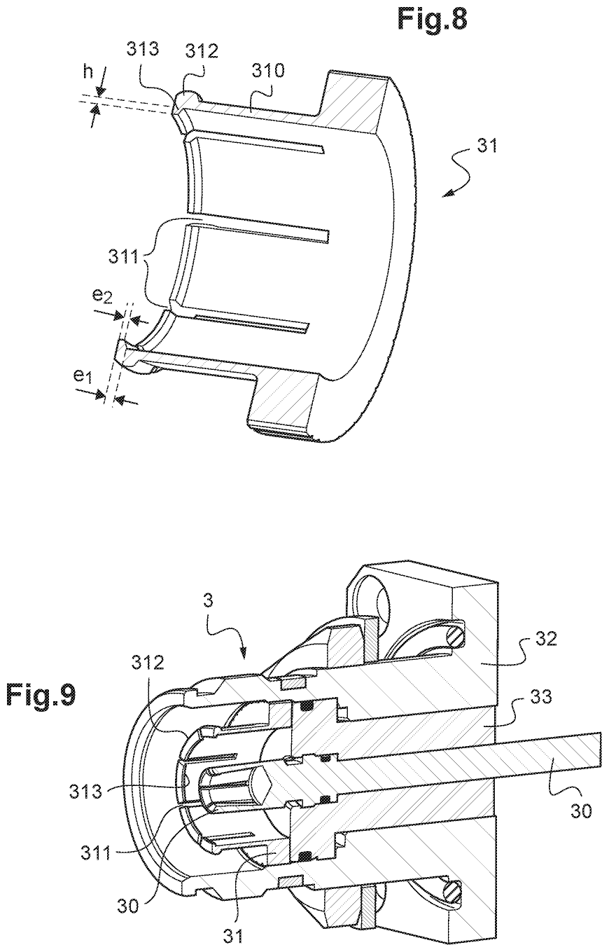

FIG. 8 is a longitudinal cross-sectional and perspective view of the slotted contact according to FIG. 7;

FIG. 9 is a longitudinal cross-sectional and perspective view of a a 4.3-10 jack equipped with a slotted contact according to the invention;

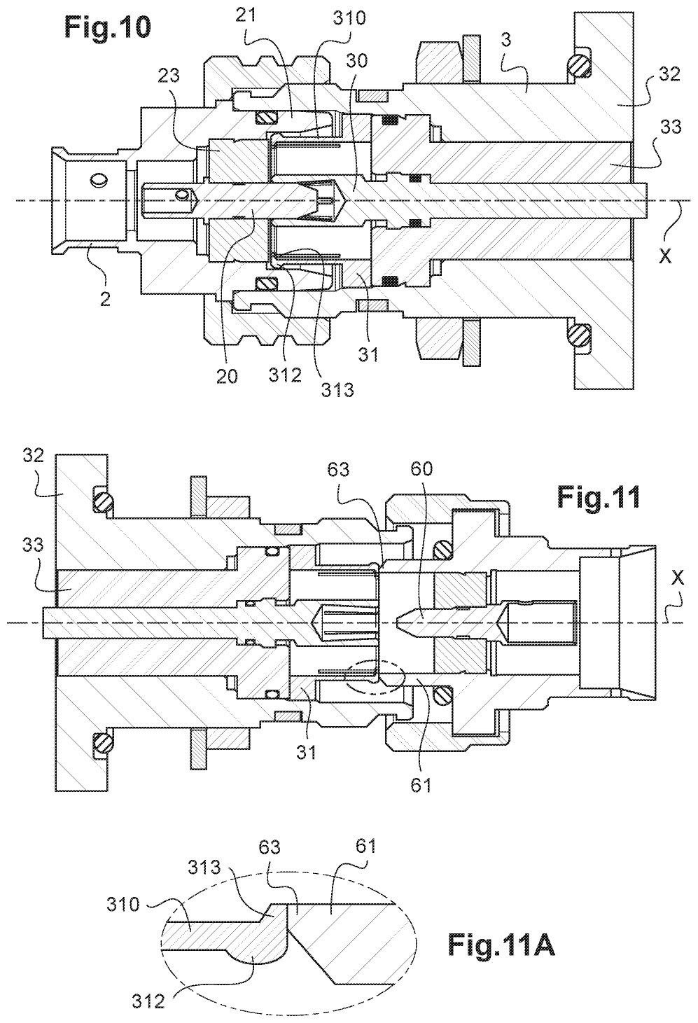

FIG. 10 is a longitudinal cross-sectional view of a coaxial connection system under series 4.3-10 according to the invention, the plug and the jack, with the slotted contact according to the invention, being in mutual connection configuration;

FIG. 11 is a longitudinal cross-sectional view showing the impossibility to connect a 4.1-9.5 plug in a 4.3-10 jack according to the invention thanks to the inwards projections of the slotted contact of the 4.3-10 jack;

FIG. 11A is a detail view of FIG. 11.

FIGS. 1 to 6 relate to different examples of coaxial connection systems according to the prior art.

These FIGS. 1 to 6 have already been commented on in the preamble and will not therefore be commented on further herein below.

In the interests of clarity, the same references designating the same elements of a connection system according to the prior art and of a 4.3-10 connection system according to the invention are used for all the FIGS. 1 to 11A.

The slotted contact 31 according to the invention has strips which are horn shaped as petals 310, said petals being distributed regularly on the cylindrical surface and separated each from other by longitudinal slits 311. Like a usual slotted contact, it is provided outwards projections 312 designed as bumps which define an exterior diameter Ø₁ of the contact 31. These bumps 312 allow a better mechanical and hence electrical contact with the interior of a ground cylindrical contact 21 of the 4.3-10 plug.

According to the invention, the petals 310 of the slotted contact 31 are each designed with a projection 313 extending inwards. In the shown embodiment, the inwards projections 313 are located only at the free end of the petals 310.

More particularly, the inwards projections 313 define a inwards diameter Ø₂ which is less than the inner diameter delimited by the cylinder of the petals 310. Typically, the inner diameter Ø₂ is of the order of 9.5 mm.

Due to the flaring of the petals 310 in order to insure a good electrical contact with the ground contact of the counterpart connector, the height h of the inwards projections 313 is typically between 0.2 mm and 0.5 mm.

As shown of FIG. 8, the inwards projections 313 may have a cross-section which decreases from the exterior towards the interior. This decreasing section may be a rectangular trapezoid with an enlarged thickness e1 of the large base which decreases up to the reduced thickness e₂ of the smaller base. It is here specified that the larger base is aligned with the inner diameter of the cylinder of the petals 310. For example, e1 may be of the order of 0.4 mm and e2 may be of the order of 0.25 mm.

Due to the fact that the inwards projections 313 do not modify the features of the bumps 312 there is no supplemental mechanical constraint when a 4.3-10 standard plug 2 is mated with a 4.3-10 jack 3 with a slotted contact 31 according to the invention.

In case of a mismating of a ground contact of a 4.1-9.5 plug connector into the inward projections 313 of the ground contact 31, the front face of the inwards projection 313 comes into abutment with said ground contact of a 4.1-9.5 plug connector.

In other words, the inwards projections 313 serve as an axial abutment to a ground contact of 4.1-9.5 plug connector

The design of the inwards projections 313 has to adapted to the requested RF performances. But, due to their slight thickness, the VSWR is not disturbed and there is absolutely no need to have a compensation of the inductive feature of the interface with the ground contact of a of 4.1-9.5 plug connector.

FIG. 10 shows the connection between an existing 4.3-10 plug 2 and a 4.3-10 jack including a slotted contact 31 with the inwards projection 313 according to the invention. It is here specified that elements 23, 33 are insulating parts interposed between the main contact 20, 30 and the ground contact 21, 31.

The slight dimensions of the inwards projections 313 allow to minimize their influence on the RF electrical performance of the connection system 1. Due to very slight influence on the RF electrical performances and no influence for intermodulation, the inwards projections 313 can be directly achieved at the free end of an existing 4.3-10 female connector with no change for the rest of its structure and its dimensions.

If an operator would mistakenly try to mate a 4.1-9.5 plug 6 with a 4.3-10 jack 3 including a slotted contact 31 according to the invention, then this latter will be avoided by creating a physical barrier by its inwards projections 313.

This situation is shown on FIGS. 11 and 11A: the front end 63 under a chamfer shape of a 4.1-9.5 plug 6 is in abutment with the inwards projections 313 at the free end of the petals of the slotted contact 31 of the 4.3-10 jack 3. Due to the intrinsic rigidity of the inwards projections 313, the ground contact 61 of a 4.1-9.5 plug 6 is in mechanical abutment against said projections 313 and hence cannot deform the petals 310 of the outer contact 31 to penetrate into.

The slotted contact 31 with the inwards projections 313 according to the invention thus avoids the risk of accidental damages of the peripheral contact 31 due to an undesired intrusion of a 4.1-9.5 plug 6 by mismating.

Other variants and enhancements can be provided without in any way departing from the framework of the invention.

For example, if the shape of the cross-section of the inwards projections 313 is shown as a rectangular trapezoid, it can be also envisaged to make any other cross-section decreasing (or stable) towards the interior of the contact 31, in the measure where the thickness of said projections is kept thin.

Also, if the inwards projections 313 are achieved only at the free end of the slotted contact 31, it can be also envisaged to make longer projections extending along the inner diameter of the cylinder of the petals. These longer projections can be extended up to the entire length of the cylinder. In this configuration, the elongated projections may be seen as an inwards oversize of the slotted contact. In this configuration also, if the elongated projections deteriorate the RF performances, it can be envisaged to reduce slightly the outer diameter of the central main contact, such as the socket contact 30.

The expression “comprising a” should be understood to be synonymous with “comprising at least one”, unless otherwise specified.

1. A slotted contact, intended to be arranged on the periphery of a central contact to form a ground contact of a 4.3-10 female connector, comprising strips which are horn shaped as petals, each petal being designed with a projection extending inwards such that in case of a mismating of a ground contact of a 4.1-9.5 plug connector into said projection, the front face of the projection comes into abutment with said ground contact of a 4.1-9.5 plug connector.

2. The slotted contact according to claim 1, wherein the inwards projection are located at the free end of the petals.

3. The slotted contact according to claim 1, the inwards projections defining an inner diameter (Ø₂) which is inferior or approximately equal to the inner diameter of the ground contact of a 4.1-9.5 plug connector.

4. The slotted contact according to claim 3, wherein the inner diameter (Ø₂) is approximately equal to 9.5 mm.

5. The slotted contact according to claim 1, wherein the height (h) of said projections compared to the inner diameter of the slotted contact is equal at least to 0.2 mm, preferably inferior or equal to 0.5 mm.

6. The slotted contact according to claim 1, wherein the projections have a longitudinal cross-section which is decreasing from the exterior towards the interior of the slotted contact.

7. The slotted contact according to claim 6, wherein the projections have a longitudinal cross-section which is a rectangular trapezoid.

8. The slotted contact according to claim 1, wherein the projections have a thickness which is at least equal to 0.2 mm.

9. The slotted contact according to claim 1, wherein the projections have a thickness which is inferior or equal to 2.5 mm.

10. A female connector of the 4.3-10 jack type for a coaxial connection system, intended to transmit radio frequency RF signals, of longitudinal axis X, the female connector comprising:
a central contact,
a peripheral slotted contact according to claim 1, arranged on the periphery of the central contact, forming a ground contact.

11. A coaxial connection system marketed under the series 4.3-10 standard designation, comprising a male connector of the type plug and a female connector of the jack type according to claim 10.
